(19) United States
(12) Patent Application Publication
(10) Pub. No.: US 2013/0192581 A1
(43) Pub. Date: Aug. 1, 2013

(54) VEHICLE HEATER WITH INTEGRATED FAN MOTOR AND CONTROL DEVICE

(71) Applicants: Michael HAEFNER, Stuttgart (DE); Andreas Collmer, Aichwald (DE); Andreas Alber, Stuttgart (DE); Christoph Köberle, Fellbach (DE); Andreas Wetzl, Wernau (DE); Oliver Sauter, Ostfildern (DE); Jörg Zweckbronner, Kuchen (DE); Benjamin Hezinger, Urbach (DE); Dieter Heybach, Hochdorf (DE); Frank Rudolf, Stuttgart (DE); Alexander Hahn, Eigeltingen-Heudorf (DE)

(72) Inventors: Michael HAEFNER, Stuttgart (DE); Andreas Collmer, Aichwald (DE); Andreas Alber, Stuttgart (DE); Christoph Köberle, Fellbach (DE); Andreas Wetzl, Wernau (DE); Oliver Sauter, Ostfildern (DE); Jörg Zweckbronner, Kuchen (DE); Benjamin Hezinger, Urbach (DE); Dieter Heybach, Hochdorf (DE); Frank Rudolf, Stuttgart (DE); Alexander Hahn, Eigeltingen-Heudorf (DE)

(21) Appl. No.: 13/566,166

(22) Filed: Aug. 3, 2012

(30) Foreign Application Priority Data
Aug. 5, 2011 (DE) DE102011109567.9
May 11, 2012 (DE) DE102012009287.3

(51) Int. Cl. B60H 1/22

(52) U.S. Cl. CPC B60H 1/2203
USPC 126/77

(57) ABSTRACT

A vehicle heater (1) has a motor (4) and a combustion air fan designed as a side channel fan. The combustion air fan has a basic housing part (2), on which a drive shaft (3) of the motor (4) is mounted, and a fan wheel (10). The fan wheel (10) is connected to the drive shaft (3) of the motor (4). The motor (4) has a stationary coil support part (6) which is connected to a printed circuit board (7) and an armature (8). Furthermore, the combustion air fan has a gap tube (16) between the stationary coil support part (6) and the armature (8).

### CROSS REFERENCE TO RELATED APPLICATIONS

This application claims the benefit of priority under 35 U.S.C. §119 of German Patent Application DE 10 2011 109 567.9 filed Aug. 5, 2011, the entire contents of which are incorporated herein by reference.

### FIELD OF THE INVENTION

The present invention pertains to a vehicle heater with a motor and with a combustion air fan designed as a side channel fan. The present invention also pertains to a vehicle that is equipped with such a vehicle heater.

### BACKGROUND OF THE INVENTION

Vehicle heaters, in which a fuel is burned in a combustion chamber for generating heat, usually have a combustion air fan designed as a side channel fan to supply the combustion chamber sufficiently with combustion air. Such fans have a stationary, ring-shaped delivery channel as well as a fan wheel mounted rotatably coaxially to the delivery channel, whose outer diameter essentially corresponds to that of the delivery channel. By rotating the fan wheel against the ring-shaped delivery channel, an air flow, which brings about a delivery of air along the delivery channel, is generated in the fan wheel as well as in the delivery channel. Besides the desired air flow, however, other effects may occur. Thus, for example, additional air flows may form in a gap between the fan wheel and a housing part having the delivery channel due to centrifugal forces acting on the air in the gap. Also, pressures differing from ambient pressure may arise in the area of the fan wheel.

A vehicle heater is known from DE 103 03 688 B3. In this vehicle heater, the motor shaft of the fan motor is mounted via ball bearings in a housing part, on whose one side a coil support is formed for the stator coil and on whose other side a side channel is formed. The motor shaft extends on both sides of the housing part, whereby on the side of the side channel a fan wheel and on the side of the coil support an armature of the fan motor is fastened to the motor shaft. Furthermore, a printed circuit board with control devices for the vehicle heater is arranged on the side of the coil support. In addition, control devices are arranged on the coil support itself for the control of the fan motor. Another fan wheel, with which heating air can be delivered by a heat exchanger of the vehicle heater, can be provided on the side of the coil support.

The drawback of the above-described design is that due to the above-described flows and pressure differences, which may occur in case of a side channel fan, depending on the embodiment of the side channel fan, a delivery of air from the side of the coil support due to the bearings of the motor shaft on the side of the side channel, as well as a delivery of air in the opposite direction may occur. Moreover, in the embodiment with an additional fan wheel for heating air, a large amount of ambient air is conveyed through areas, in which the printed circuit board with the control devices is arranged and in which are located the coil support of the fan motor as well as possibly other control devices for the motor.

By means of air that is conveyed through the bearings of the motor shaft, moisture as well as contaminants in the form of fuels, oil or particles can reach the coil support, the control devices and other electric components on the printed circuit board. In addition, air drawn in by the heating fan may contain moisture and possibly also salt water when the vehicle heater is operated in watercraft. As a result of this, damage may be caused to electric components or the stator coil by contaminants, abrasion or corrosion, which may lead up to a failure of the vehicle heater.

A cover of individual electronic components, which lie in the area of the flow of heating air fed in, is disclosed in the publication DE 103 03 688 B3 in this connection. However, the disclosed cover does not protect all affected electronic components. Thus, for example, electronic components or the control devices arranged on the stator coils as well as the stator coils themselves may not be covered by the disclosed cover. The disclosed cover is thus only partly effective against damage to the vehicle heater by the heating air fed in. In addition, components are not protected against the air and substances that are conveyed through the bearings of the motor as described above.

### SUMMARY OF THE INVENTION

An object of the present invention is to design a vehicle heater of this type, such that all the control devices and other electronic components as well as stator coils and the entire printed circuit board are sufficiently protected against influences due to the heating air or other air flows occurring, and thus, for example, against moisture, contamination, abrasion or corrosion.

According to an especially advantageous embodiment, the vehicle heater comprises a motor and a combustion air fan designed as a side channel fan. The combustion air fan has a basic housing part, at which a drive shaft of the motor is mounted, and a fan wheel. The fan wheel is connected to the drive shaft of the motor, whereby the motor has a stationary coil support part connected to a printed circuit board as well as an armature. Also, a gap tube (slit tube) is provided between the stationary coil support part and the armature in the combustion air fan according to the present invention.

By means of this embodiment, in the interior of the fan motor, air from the area of the ball bearings of the motor shaft is prevented from entering an air space surrounding the stator coils. Thus, no corrosive or abrasive media or impurities from the side channel can be conveyed through the ball bearings to the stator coils or electronic components in their vicinity.

According to another advantageous embodiment of the vehicle heater, the gap tube has a continuation, whereby the basic housing part together with the gap tube and the continuation of the gap tube completely enclose the printed circuit board.

In this way, a gas-tight, enclosed space is formed, which encloses all electronic components and the stator coils. Thus, all components, which are sensitive to damage by air flows, are protected both against flows from the combustion air fan and against flows from the heating air fan.

According to another advantageous embodiment, the vehicle heater comprises on the printed circuit board a control device that is provided to control the motor and to control the vehicle heater.

Compared to an arrangement of the motor control devices on the coil supports, all control devices can be arranged on the printed circuit board in an especially cost-effective manner.

According to another advantageous embodiment of the vehicle heater, the combustion fan has a fan housing part with a side channel, whereby the basic housing part and the fan housing part form a space enclosing the fan wheel.

Thus, the fan wheel is prevented from rotating in the space impacted by the fan pressure on the combustion chamber side of the basic housing. Instead of this, the fan wheel rotates in a separate space, in which to some extent half the pressure prevails compared to the space impacted by the fan pressure. Thus, the fan can be operated with a higher efficiency, since, for example, gap losses are reduced. Also, the sound emission due to the fan wheel in the outward direction can be reduced by this embodiment.

According to another advantageous embodiment, the fan housing part is arranged on a side of the fan wheel, which is facing a combustion chamber of the vehicle heater.

By means of this embodiment, rotating parts are prevented from being located in the area of the combustion chamber, which can lead to damage to lines such as cables of a glow plug, a sensor or a heating system of, for example, a fuel evaporator.

According to another advantageous embodiment, a combustion air outlet of the combustion air fan is arranged on one side of the fan housing part facing the combustion chamber of the vehicle heater.

Thus, a space-saving and flow-favorable feed of combustion air to the combustion chamber is made possible, in which a costly deflection of the air flow around the fan wheel can be dispensed with.

According to another advantageous embodiment, sections of the gap tube and/or of the continuation of the gap tube have a cylindrical design and are arranged concentric to a jacket surface of the heater housing and/or of the drive shaft of the motor.

Such an embodiment increases the stability of the gap tube and of the continuation of the gap tube and additionally makes possible the secure and simple mounting of other housing parts at the gap tube or continuation of the gap tube.

According to another advantageous embodiment, a connecting device is provided at the gap tube and/or continuation of the gap tube for electric contacting of the control devices on the outside of a space around the printed circuit board formed by the basic housing part, the gap tube and the continuation of the gap tube.

In this way, an electric connection of the electronic components arranged in the gas-tight space can be embodied via a contact, designed as gas-tight, for example, a plug-type connection to supply them, for example, with current.

According to another advantageous embodiment, fastening devices are provided on the side of the fan housing part, which is facing the combustion chamber, for fastening lines of the vehicle heater.

Lines such as cables of a glow plug, of a sensor or of a heating system can thus be prevented from slipping and thus from coming into contact with hot parts, such as, for example, of a heater for evaporating fuel.

According to another advantageous embodiment, the vehicle heater is provided in a vehicle.

By using the vehicle heater according to the present invention in a landcraft or watercraft, air can be heated directly for heating the vehicle interior and be brought into the vehicle interior, or a cooling water circuit of the vehicle can be heated, whereby air can be heated via a heat exchanger, which is fed to the vehicle interior.

Other features and advantages of the present invention arise from the following description of exemplary embodiments of the present invention on the basis of the figure, which shows features essential to the present invention, and from the claims. The individual features can be embodied each individually or in a plurality in any combination in a variant of the present invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic sectional view of an embodiment of a vehicle heater with a fan wheel for conveying combustion air and with a fan wheel for conveying heating air.

### DESCRIPTION OF THE PREFERRED EMBODIMENTS

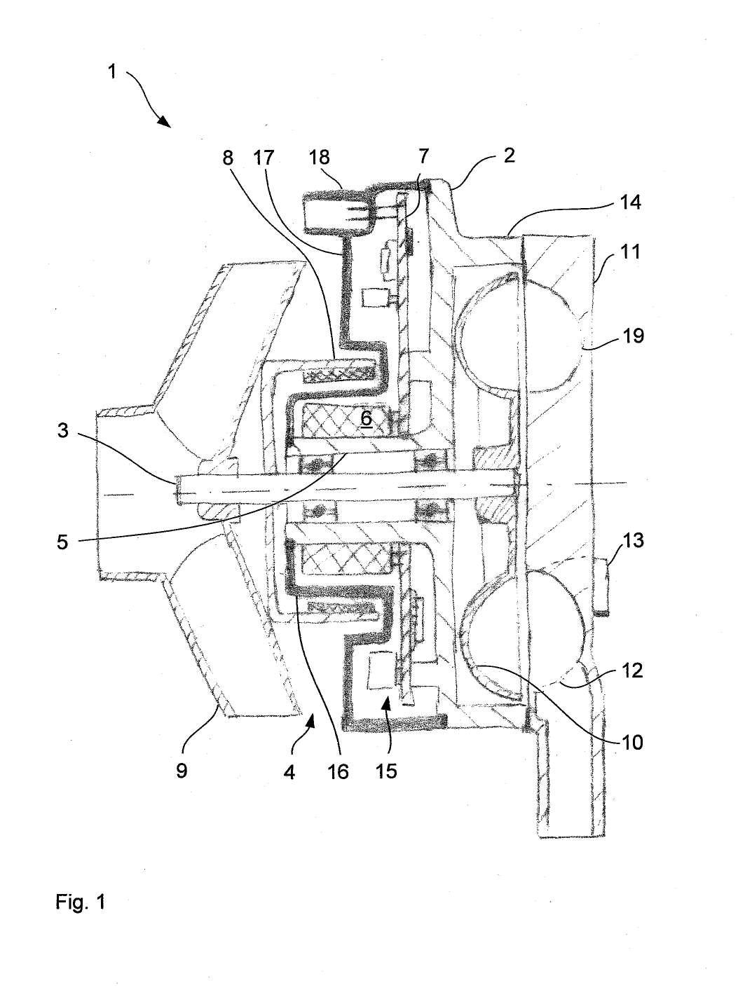

Referring to the drawings in particular, an embodiment of the present invention is shown in FIG. 1, which shows a vehicle heater 1 arranged in a motor vehicle (not shown), which comprises a basic housing part 2, in which a motor shaft 3 of a fan motor 4 is mounted. The basic housing part 2 is essentially disk-shaped and has in its center a continuation 5 designed as a hollow cylinder on the side shown in FIG. 1 on the left. The motor shaft 3 runs through the hollow-cylindrical continuation 5 and projects over same on both sides, whereby the motor shaft 3 is mounted inside the continuation 5 via two ball bearings. A stator coil 6, which is rigidly connected to a printed circuit board 7 on a front side facing the basic housing part 2, is pressed onto the outside of continuation 5. The printed circuit board 7 is arranged essentially parallel to the disk-shaped main body of basic housing part 2 and fastened to projections of the basic housing part 2. On the same side of the basic housing part 2, an armature 8 or rotor of the fan motor 4, which is designed with permanent magnets, is also mounted at the motor shaft 3, such that the permanent magnets of the armature 8 are arranged rotatably about the stator coil 6. Following the armature 8, a heating air fan wheel 9 is also mounted at the motor shaft 3.

On the side of the basic housing part 2 shown in FIG. 1 on the right side, a fan wheel 10 is mounted at the motor shaft 3 for conveying combustion air. The combustion air fan is designed as a side channel fan. For this purpose, the fan wheel 10 has on its circumference a circular-ring-like recess, which is open towards the side facing away from the basic housing part 2. The circular-ring-like recess has bars, running in the radial direction, which divide the recess into a large number of individual chambers. A fan housing part 11, which likewise has an essentially disk-shaped design and is arranged essentially parallel to the basic housing part 2 and to the fan wheel 10, is provided as a counterpiece to the fan wheel 10. Analogously to the fan wheel 10, the fan housing part 11 has a circular-ring-shaped recess or a circular-ring-like delivery channel 19, which is open towards the fan wheel 10. The delivery channel 19 of the fan housing part 11 is arranged coaxially to the recess of the fan wheel 10 and has essentially the same outer diameter. By rotating the fan wheel 10 against delivery channel 19, an air flow, which brings about a conveying of air along delivery channel 19, is produced in the fan wheel 10 as well as in delivery channel 19. Delivery channel 19 is not designed as a completely formed circular ring, but rather has an interruption at one point. At the thus forming ends of delivery channel 19, at one end is provided an air inlet 12 that is connected to a channel leading radially outwards for drawing in ambient air. At the other end is provided an air outlet 13, which is open in the axial direction on the side of the fan housing part 11 situated on a combustion chamber of the vehicle heater 1. Fan housing part 11 is connected to the basic housing part 2 via a continuation 14 of the basic housing part 2 designed as a hollow cylinder, as a result of which a cylindrical chamber accommodating the fan wheel 10 forms. Thus, the fan wheel 10 does not run on the pressure side of the fan, but rather in a separate chamber, in which to some extent half the pressure prevails compared to the pressure side of the fan.

A combustion chamber (not shown) of the vehicle heater 1 is connected on the side of the fan housing part 11 shown in FIG. 1 on the right side. Since the fan wheel 10 is not, as described above, located on the side of the combustion chamber, but rather the fan housing part 11, rotating parts are not located on the side of the combustion chamber. Thus, brackets for lines, which are necessary for the operation of the vehicle heater 1, such as, for example, lines for sensors or current feeds for a glow plug and for a heating element for evaporating fuel to be burned, can be attached to the fan housing part 11.

Control devices 15 or electronic components for control of the fan motor 4 and the vehicle heater 1 as well as other electronic components are provided on the printed circuit board 7. In order to protect the control devices 15, other electronic components and the stator coil 6 against corrosion, abrasion or contamination, a gap tube 16 extends from a front side of the stator coil 6 facing away from the basic housing part 2 first in the radial direction and then in the axial direction along an air gap between the armature 8 and the stator coil 6. In this way, a cup-shaped body surrounding the stator coil 6 forms, which is connected to same in a circumferential, gas-tight manner on the front side of the stator coil 6 facing away from the basic housing part 2.

At the end of the air gap that is facing the basic housing part 2, the gap tube 16 is extended by a continuation 17 of the gap tube 16, which extends in the radial direction up to at the outer edge of the basic housing part 2. In the present exemplary embodiment, the gap tube 16 is designed in one piece with the continuation 17 of the gap tube 16. In the outer area, the continuation 17 of the gap tube 16 again runs in the axial direction, so that in this area a hollow cylinder is formed, which is connected to the basic housing part 2 in a circumferential, gas-tight manner at its lower end. In this way, a gas-tight space, which completely surrounds the printed circuit board 7, is formed by the gap tube 16 together with the continuation 17 of the gap tube 16 and the basic housing part 2. Thus, corrosive or abrasive substances as well as contaminations with the air that is fed by the bearings of the motor shaft 3 on the side of the motor 4, are prevented from reaching control devices 15, other electronic components or the stator coil 6. Also, substances are prevented from being conveyed to these structural elements via the heating air fan wheel 9. The gap tube 16 and possibly continuation 17 of the gap tube 16 are made of a non-magnetic material such as, for example, plastic, in order to not compromise the mode of operation of the motor 4.

Further, an electric connection 18, which can be designed, for example, as a plug contact, is provided for contacting the control devices 15 or other electronic components. Electric connection 18 may be designed, for example, such that metallic contact pins of the printed circuit board 7 are led through an opening in continuation 17 of the gap tube 16. For contacting, a connector head with corresponding electric plug contacts can be plugged onto the contact pins, whereby the connector head is designed such that it seals the opening in the plugged-in state in a gas-tight manner.

The present invention may be applied, as described, to air heaters or even to water heaters. In water heaters, usually a cooling water circuit of a landcraft or watercraft is heated, whereby air is heated in a heat exchanger by the cooling water and can be fed to the vehicle interior. Instead of the suggested sealing by means of a gap tube, gas-tight bearings may also be used for mounting the motor shaft, whereby this would be connected with increased frictional losses as well as increased costs.

Even though certain elements, embodiments and applications of the present invention have been shown and described, it is understood that the present invention is not limited thereto and the person skilled the art may make modifications without deviating from the range of validity of the present disclosure, especially in view of the above teaching.

While specific embodiments of the invention have been shown and described in detail to illustrate the application of the principles of the invention, it will be understood that the invention may be embodied otherwise without departing from such principles.

What is claimed is:

1. A vehicle heater comprising:
a motor;
a motor drive shaft;
a combustion air fan designed as a side channel fan, said combustion air fan has a basic housing part, on which said motor drive shaft is mounted and a fan wheel connected to said motor drive shaft;
a printed circuit board, said motor having a stationary coil support part connected to said printed circuit board and having an armature; and
a combustion air fan gap tube between said stationary coil support part and said armature.

2. A vehicle heater in accordance with claim 1, wherein said gap tube comprises a gap tube continuation, whereby said basic housing part together with said gap tube with said gap tube continuation completely encloses said printed circuit board.

3. A vehicle heater in accordance with claim 1, wherein a control device is provided on said printed circuit board to control said motor and to control said vehicle heater.

4. A vehicle heater in accordance with claim 1, wherein said combustion air fan has a fan housing part with a side channel, whereby said basic housing part and said fan housing part form a space enclosing said fan wheel.

5. A vehicle heater in accordance with claim 4, wherein said fan housing part is arranged on one side of said fan wheel which is facing a combustion chamber of the vehicle heater.

6. A vehicle heater in accordance with claim 1, wherein said combustion air fan has a combustion air outlet arranged on a side of said fan housing part facing a combustion chamber of the vehicle heater.

7. A vehicle heater in accordance with claim 1, wherein said gap tube comprises sections of a cylindrical design arranged concentric to a jacket surface of the heater housing and/or said motor drive shaft.

8. A vehicle heater in accordance with claim 1, further comprising a connecting device provided at said gap tube for electric contact with said printed circuit board outside of a space around said printed circuit board formed by said basic housing part and said gap tube.

9. A vehicle heater in accordance with claim 5, further comprising fastening devices for fastening lines of vehicle heater provided on said side of said fan housing part that is facing the combustion chamber.

10. A vehicle heater in accordance with claim 2, wherein said gap tube comprises sections and/or of said continuation of said gap tube having a cylindrical design and arranged concentric to a jacket surface of the heater housing and/or said motor drive shaft.

11. A vehicle heater in accordance with claim 2, further comprising a connecting device provided at said continuation of the gap tube for electric contact with said printed circuit board outside of a space around said printed circuit board formed by said basic housing part and said gap tube.

12. A vehicle comprising:
a vehicle heater comprising:
a motor;
a motor drive shaft;
a combustion air fan designed as a side channel fan, said combustion air fan has a basic housing part, on which said motor drive shaft is mounted and a fan wheel connected to said motor drive shaft;
a printed circuit board, said motor having a stationary coil support part connected to said printed circuit board and having an armature; and
a combustion air fan gap tube between said stationary coil support part and said armature.

13. A vehicle in accordance with claim 12, wherein said basic housing part together with said gap tube with said gap tube defines a completely enclosed space with said printed circuit board in said completely enclosed space.

14. A vehicle in accordance with claim 12, wherein a control device is provided on said printed circuit board to control said motor and to control said vehicle heater.

15. A vehicle in accordance with claim 12, wherein said combustion air fan has a fan housing part with a side channel, whereby said basic housing part and said fan housing part form a space enclosing said fan wheel.

16. A vehicle in accordance with claim 15, further comprising a combustion chamber, wherein said fan housing part is arranged on one side of said fan wheel which is facing said combustion chamber.

17. A vehicle in accordance with claim 16, wherein said combustion air fan has a combustion air outlet arranged on a side of said fan housing part facing said combustion chamber of the vehicle heater.

18. A vehicle in accordance with claim 12, wherein said gap tube comprises sections of a cylindrical design arranged concentric to a jacket surface of the heater housing and/or said motor drive shaft.

19. A vehicle in accordance with claim 12, further comprising a connecting device provided at said gap tube for electric contact with said printed circuit board outside of a space around said printed circuit board formed by said basic housing part and said gap tube.

20. A vehicle heater comprising:
a motor;
a motor drive shaft;
a combustion air fan comprising a basic housing part, on which said motor drive shaft is mounted, a fan wheel connected to said motor drive shaft and a fan housing part with a side channel, whereby said basic housing part and said fan housing part form a space enclosing said fan wheel;
a printed circuit board, said motor having a stator coil with stator support connected to said printed circuit board and having an armature mounted for rotation with said motor drive shaft, said armature and said stator coil being spaced apart by a gap; and
a combustion air fan gap tube between said stationary coil support part and said armature.
